(19) United States
(12) Patent Application Publication
(10) Pub. No.: US 2004/0174703 A1
(43) Pub. Date: Sep. 9, 2004

(54) Flexible flashlight with LED light source

(75) Inventor: Kevin L. Tally, Clarinda, IA (US)

Correspondence Address: BANNER & WITCOFF, LTD., TEN SOUTH WACKER DRIVE, SUITE 3000, CHICAGO, IL, 60606, US

(73) Assignee: Lisle Corporation, Clarinda, IA

(21) Appl. No.: 10/378,787

(22) Filed: Mar. 4, 2003

(51) Int. Cl. F21L 4/04

(52) U.S. Cl. 362/202

(57) ABSTRACT

A flashlight comprises a light source element connected to flexible lead wires powered by batteries in a tubular housing. The electrical connection provides series circuit and a special control button arrangement provides for closing or opening of the series circuit to the light element.

### BACKGROUND OF THE INVENTION

In a principal aspect the present invention relates to a flashlight comprised of a light or light source (particularly a light emitting diode (LED)) mounted on the end of a flexible wire so that the light source may be positioned to focus light in a restricted region. The wire extends from a rigid tube which holds the battery or electric power source that powers the light source at the end of the flexible wire. A special control button arrangement is incorporated in the rigid, battery storage tube to turn the light source on and off as desired.

The use of a flashlight which provides for placement of an incandescent bulb or other light source at the end of a flexible wire and powered by batteries retained in a housing to which the wire is connected is a known expedient. The flashlight of such a construction is especially useful for providing light in a restricted area or space such as encountered when a mechanic is attempting to repair a vehicle engine and desires to examine various highly inaccessible portions of an engine block or ancillary equipment attached to the engine. Heretofore incandescent bulbs have been used for such purposes. However, the lifespan and vulnerability of such a bulb, particularly in a hostile environment, may not be acceptable. Thus there has developed the need for an improved flexible flashlight, particularly such a flashlight which includes a control mechanism or control means for providing current to the light element in a positive but controllable manner and which uses a long life, low current light source such as a light emitting diode (LED) and which has a high resistance to undesirable environmental conditions including vibration, shock and industrial fluids.

### SUMMARY OF THE INVENTION

Briefly the present invention comprises a flexible flashlight which includes a light source or light element positioned at the end of the flexible two-lead wire. The light element preferably comprises a light-emitting diode (LED). The diode is in a series connection with a first lead wire through the diode and a second wire from the diode. The lead wires are connected to a battery housing or battery case. Typically the battery housing or battery case comprises a cylindrical tube with the lead wires connected at one end and a control button or control mechanism at the opposite end. The control mechanism may be operated to close a circuit and thereby provide current to the diode.

The flexible wire connecting the battery housing to the diode may be bent to a desired configuration so as to enable the diode to be positioned in a desired, highly-inaccessible place. The control mechanism or button associated with the battery housing may then be operated to close the circuit and positively power the diode. Alternatively, the control mechanism may be positively operated to open the circuit and thus turn off the light-emitting diode.

Thus, it is an object of the invention to provide an improved flexible flashlight construction.

A further object of the invention is to provide a flexible flashlight construction which is capable of being utilized with a light-emitting diode or an incandescent bulb.

Yet another object of the invention is to provide a flexible flashlight which is economical, easy to use and in which batteries for powering the flashlight may be easily incorporated in a housing to thereby power an incandescent light or a light-emitting diode.

A further object of the invention is to provide a rugged, yet highly efficient and effective, flexible flashlight.

These and other objects advantages and features of the invention will be set forth in the detailed description which follows:

### BRIEF DESCRIPTION OF THE DRAWING

In the detailed description which follows, reference will be made to the drawing comprised of the following figures:

FIG. 1 is a cross sectional view of the flexible flashlight of the invention;

FIG. 2 is an enlarged cross sectional view of the button control mechanism of the flashlight of FIG. 1; and

FIG. 3 is an isometric view of the assembled flashlight of the invention.

### DESCRIPTION OF THE PREFERRED EMBODIMENT

Referring to the figures, the flexible flashlight of the invention includes a light element 10, for example, a light-emitting diode (LED) connected with a flexible, first lead wire 12 and a flexible, second lead wire 14 retained within a flexible tube or housing 16. The flexible lead wires 12, 14 as well as the housing 16 may be manually manipulated and adjusted to a desired configuration so as to permit placement of the light source element 10 in a very small or restricted space in which light is required. Note that the light source element 10 may be a visible light-emitting diode, an ultra-violet light-emitting diode or an incandescent bulb. However, an LED is preferred because of its long life, low current requirements, and tolerance to environmental conditions.

The first and second lead wires 12, 14 as well as the tubular housing 16 for the lead wires 12, 14 are fitted through a conductive metal nose piece 20 attached to a cylindrical, tubular, battery housing 22. The lead wires 12, 14 are covered by insulating material and engage with an insulating connector 24 which positions the conductive end of the first lead wire 12 so that it can engage with a positive pole 26 of a battery 28 arranged in series with additional batteries 28 within the tubular housing 22. Thus, first lead wire 12 provides a series connection with the batteries 28.

The conductive end of the second lead wire 14 is retained by the fitting or connector 24 in electrical contact with the conductive metal nose piece 20 which, in turn, is in electrical contact with the battery housing 22 comprised of a conductive metal. Because the batteries 28 are low voltage, there is no opportunity for shock associated with the particular arrangement of batteries 28 and conductive housing 22. The housing 22 may be conductive or, alternatively, there may be a conductive path provided in the housing 22 to the opposite end of the housing 22 for operation with the knob or button control mechanism described hereinafter.

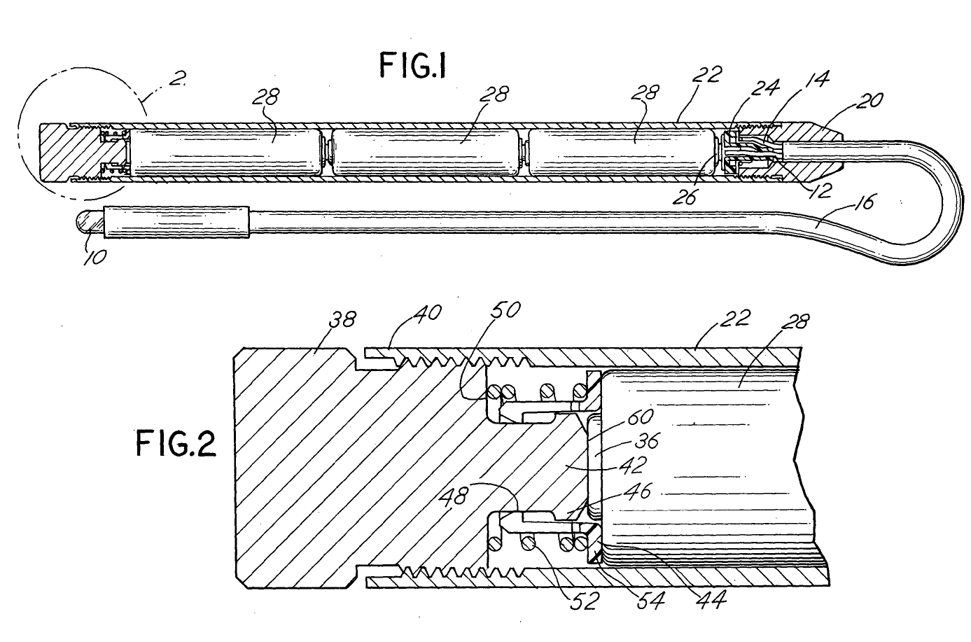

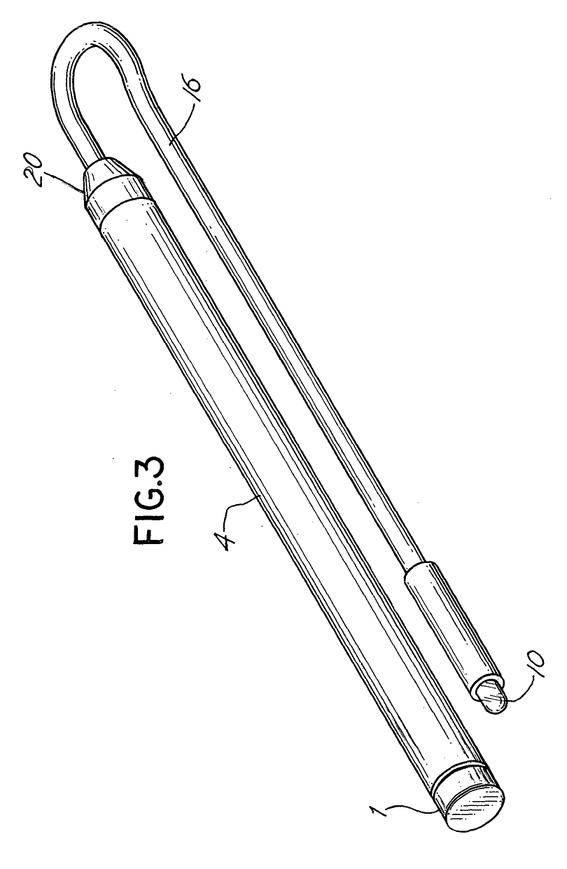

Referring therefore to FIG. 2 the battery housing 22 is illustrated in enlarged cross sectional view with a battery 28 and, more particularly, a negative pole 36 thereof positioned for engagement with a rotational, generally-cylindrical control mechanism including a knob or button control member 38 threadably attached to open end 40 of the battery housing 22. The knob or button 38 includes a conductive knob or projection 42. Thus, the button 38 provides a conductive path from the housing 22 through the button 38 and the extending knob or projection 42 to engage the negative pole 36 of the battery 28.

An annular insulating member 44 fits over a peripheral flange 46 of the knob 42. The insulating member 44 includes a central passage 48 which slips or fits over the knob 46. Thus, the insulating member 44 is retained on the knob 42 and may move slidably in an axial direction between a land 50 and a circumferential or peripheral flange 46. A spiral biasing spring 52 is interposed between the land 50 and the peripheral rib or flange 54 of the insulating member 44. The spring 52 biases the flange 54 as well as the batteries 28 into the housing 22.

Rotating or screwing the button mechanism or button 38 will close the space between conductive end 60 of the knob or projection 42 and the pole 36 of the battery 28 to provide a completed series circuit through the flashlight. Reversing the rotation of the button 38 will effect a release of the knob or projection 42 from engagement with the pole 36 inasmuch as the spring 52 will push the batteries and related elements within the housing 22 to the right as viewed in FIG. 2.

With the construction described, the series circuit is positively closed upon rotating the button member or button 38 inwardly and is disengaged and maintained in disengagement upon reverse rotation of the button 38. The insulating member 44 is retained on the knob 42 by virtue of the peripheral flange 46 of the knob 42. Thus the entire control mechanism associated with the button 38 may be removed from the tube 22 for replacement of batteries 28 without loss of the various elements comprising the button mechanism.

Various alternative constructions incorporating the features of the invention may be adopted. For example, the shape of battery housing 22, the shape and number of the batteries 28, the particular configuration of the insulated member 24 may all be varied. The particular diode or incandescent bulb or lighting element which is utilized in the combination may be varied without departing from the spirit and scope of the invention. The invention is therefore limited only by the following claims and equivalents thereof.

What is claimed is:

1. A flashlight comprising, in combination:
a light source element;
a elongate first flexible lead wire;
an elongate second flexible lead wire, said first and second lead wires connected to the light source element in series;
a separate battery housing having a lead wire end and a manual button operating end, said housing including a battery tube for receipt of at least one battery, said housing further including a lead wire fitting at the lead wire end for receipt of the first and second lead wires and for maintaining the first lead wire electrically connected to a battery in the housing, said housing further including a conductive series path to the second end, said lead wire fitting also electrically connecting the second lead wire in series to a battery pole of a battery in the housing;
a button control mechanism for the flashlight mounted at the second end of the housing, said button control mechanism including a first series circuit connection between the series path and the button control mechanism, said button control mechanism comprising a conductive rod member with a projecting conductive knob for electrical contact with a battery in the housing to complete a series circuit through the battery, an insulator fitted on the rod member and a spring fitted over the insulator for biasing the insulator against a battery in the housing and away from the conductive knob, said conductive knob being longitudinally adjustable to engage the knob against a battery pole in the housing to close the series circuit and energize the light source element.

2. The flashlight of claim 1 wherein the spring, knob and insulator are coaxial.

3. The flashlight of claim 1 wherein the insulator is comprised of a center tube with a peripheral flange for engaging the spring.

4. The flashlight of claim 3 wherein the spring is a spiral spring.

5. The flashlight of claim 1 wherein the knob includes a retention flange for engaging and retaining the insulator slidably mounted on the knob.
